(19) United States
(12) Patent Application Publication
(10) Pub. No.: US 2022/0108409 A1
(43) Pub. Date: Apr. 7, 2022

(54) Energy System and Local Energy Market

(71) Applicant: Siemens Aktiengesellschaft, München (DE)

(72) Inventors: Sebastian Schreck, Nürnberg (DE); Sebastian Thiem, Neustadt an der Aisch (DE)

(73) Assignee: Siemens Aktiengesellschaft, München (DE)

(21) Appl. No.: 17/428,324

(22) PCT Filed: Jan. 23, 2020
(86) PCT No.: PCT/EP2020/051591

§ 371 Date: Aug. 4, 2021

(30) Foreign Application Priority Data
Feb. 5, 2019 (DE) 10 2019 201 463.1

(51) Int. Cl. G06Q 50/06; H02J 3/00; H02J 3/14

(52) U.S. Cl. CPC G06Q 50/06; H02J 3/008; H02J 2310/12; H02J 3/144; H02J 3/003

(57) ABSTRACT

Various embodiments of the teachings herein include an energy system comprising: a central control unit; and an energy subsystem including an energy storage unit having a total storage capacity. The central control unit is programmed to control the energy storage unit based on an optimization. The total storage capacity of the energy storage unit is divided into a first partial storage capacity and a second partial storage capacity by the control unit for the optimization. The first partial storage capacity is designated for internal use with respect to the energy subsystem. The second partial storage capacity is designated for external use with respect to the energy subsystem.

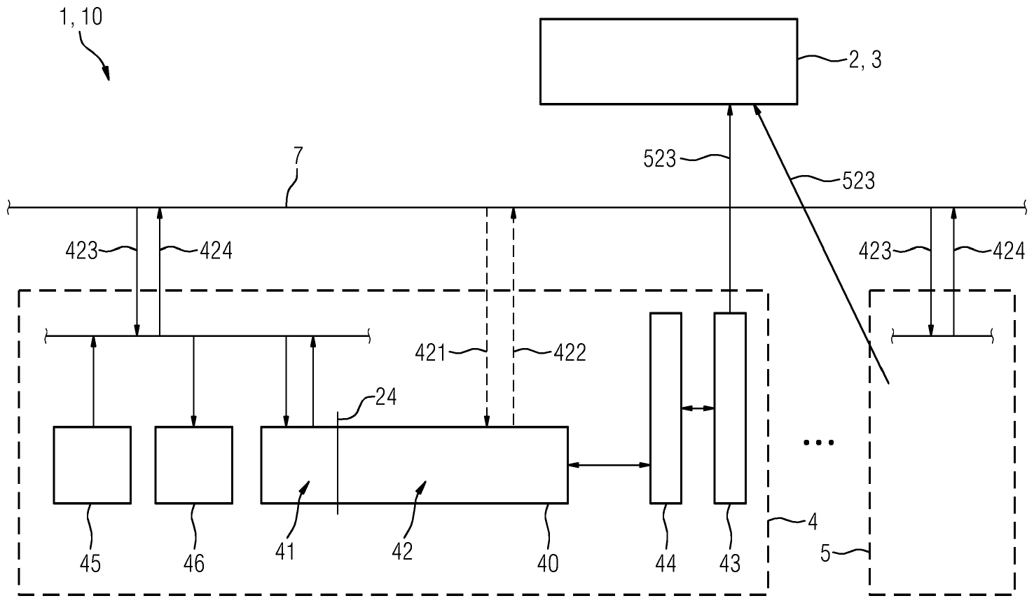

### CROSS-REFERENCE TO RELATED APPLICATIONS

This application is a U.S. National Stage Application of International Application No. PCT/EP2020/051591 filed Jan. 23, 2020, which designates the United States of America, and claims priority to DE Application No. 10 2019 201 463.1 filed Feb. 5, 2019, the contents of which are hereby incorporated by reference in their entirety.

### TECHNICAL FIELD

The present disclosure relates to energy systems, local energy markets, and/or methods for operating an energy system.

### BACKGROUND

Local energy systems that provide and/or consume electrical energy through their energy subsystems will become of increasing importance in the future due to the liberalization of the energy market. Examples of local energy systems are a supply region of a distribution network operator, a city district and/or a municipality. Local energy systems do not generate the electrical energy—as has been known up to now—centrally through power plants, but rather in a decentralized manner by way of components of smaller energy subsystems, for example combined heat and power plants and/or private photovoltaic systems. The locally provided energy is likewise consumed locally by the energy subsystems of the energy system. A local energy system thus typically has producers, consumers and prosumers (as they are known) that exchange energy and produce and/or consume the exchanged electrical energy themselves. If electrical energy is also able to be traded between the energy subsystems by way of such a local energy system, then these form a local energy market.

Energy systems may also have an energy storage unit, in particular a battery storage unit. By way of example, many private dwellings (energy subsystem) comprise a photovoltaic system having an associated battery storage unit. In this case, the battery storage unit should typically be used as optimally as possible with regard to its own use, that is to say internal use with respect to the energy subsystem. However, it would likewise be advantageous for the battery storage unit to be able to be used by further energy subsystems of the energy system, that is to say by energy subsystems that are external with respect to the energy subsystem comprising the battery storage unit. The electrical energy generated by way of a photovoltaic system of an energy subsystem could thereby be buffer-stored by way of a battery storage unit of a further energy subsystem of the energy system.

### SUMMARY

The teachings of the present disclosure allow internal and external use of an energy storage unit within an energy system. For example, some embodiments include an energy system (1), comprising a central control unit (2) and at least one energy subsystem (4), wherein the energy subsystem (4) comprises an energy storage unit (40) having a total storage capacity, and the control unit (2) is designed at least to control the energy storage unit (40) based on an optimization, characterized in that the total storage capacity of the energy storage unit (40) is able to be divided into a first partial storage capacity (41) and a second partial storage capacity (42) by the control unit (2) for the optimization, wherein the first partial storage capacity (41) is intended for internal use with respect to the energy subsystem (4) and the second partial storage capacity (42) is intended for external use with respect to the energy subsystem (4).

In some embodiments, the first and second partial storage capacity (41, 42) are variables of the optimization.

In some embodiments, the control unit (2) is designed to control charging and/or discharging of the energy storage unit (4) based on a solution to the optimization.

In some embodiments, the system comprises a data interface (523) for transferring data containers between the energy subsystem (4) and the control unit (2), wherein the data of the transferred data containers are able to be taken into consideration by the control unit (2) at least partially in the optimization.

In some embodiments, the system comprises a database (3) for storing and/or reading the data containers exchanged by way of the data interface (523).

In some embodiments, the database (3) is formed by way of a blockchain.

In some embodiments, the energy subsystem (4) comprises a measuring unit (43) for acquiring physical measured variables of the energy storage unit (40), wherein the acquired measured variables are able to be transferred, by way of the measuring unit (44), to the control unit (2) via the data interface (523) by way of data containers.

In some embodiments, the energy subsystem (4) comprising the energy storage unit (40) is a single-family dwelling or multiple-family dwelling.

In some embodiments, the system comprises a plurality of energy subsystems (4, 5) and a power network (7) that electrically couples the energy subsystems (4, 5) in order to exchange electrical energy.

As another example, some embodiments include a local energy market (10), characterized in that it comprises an energy system (1) as described herein, and electrical energy is able to be exchanged between the energy subsystems (4, 5) by way of the power network (7) in accordance with the optimization, and wherein the optimization is able to take into consideration offers and/or bids, transmitted to the control unit (2), of the energy subsystems (4, 5) with regard to their consumption and/or provision of electrical energy.

In some embodiments, the offers and/or bids are able to be transmitted to the control unit (2) peer-to-peer and/or by way of a blockchain.

In some embodiments, at least the energy subsystem (4) comprising the energy storage unit (40) is designed to transmit an offer for the storage of electrical energy by way of the energy storage unit (40) to the control unit (2).

As another example, some embodiments include a method for operating an energy system (1), wherein the energy system (1) comprises at least one energy subsystem (4) and a central control unit (2), and the energy subsystem (4) has an energy storage unit (40) having a total storage capacity, wherein the control unit (2) controls the energy storage unit based on an optimization, characterized in that the total storage capacity of the energy storage unit (40) is divided into a first partial storage capacity (41) and a second partial storage capacity (42) by the control unit (2) for the optimization, wherein the first partial storage capacity (41) is used for internal use with respect to the energy subsystem (4) and the second partial storage capacity (42) is used for external use with respect to the energy subsystem (40).

In some embodiments, the control unit (2) controls charging and/or discharging of the energy storage unit (40) based on a solution to the optimization.

In some embodiments, the energy system (1) has a plurality of energy subsystems (4, 5), wherein the control unit (2) controls the exchange of electrical energy between the energy subsystems (4, 5) based on the optimization, taking into consideration the division of the energy storage unit (40) into the first and second partial capacity (41, 42).

### BRIEF DESCRIPTION OF THE DRAWINGS

Further advantages, features and details of the teachings herein are apparent from the exemplary embodiments described below and with reference to the drawing. In this case, the single figure shows a schematic block diagram of an energy system according to one embodiment of the teachings of the present disclosure. Identical, equivalent or functionally identical elements may be provided with the same reference signs in the figure.

### DETAILED DESCRIPTION

In some embodiments, an energy system comprises at least one central control unit and at least one energy subsystem, wherein the energy subsystem comprises an energy storage unit, in particular a battery storage unit, having a total storage capacity, and the control unit is designed at least to control the energy storage unit based on an optimization. In some embodiments, the total storage capacity of the energy storage unit is divided into a first partial capacity and a second partial capacity by the control unit for optimization, wherein the first partial capacity is intended for internal use with respect to the energy subsystem and the second partial capacity is intended for external use with respect to the energy subsystem. In other words, the first partial capacity is designed and/or able to be used for internal use with respect to the energy subsystem and the second partial capacity is designed and/or able to be used for external use with respect to the energy subsystem.

In the present disclosure, the term control likewise comprises regulation. This means that the control unit may also be a regulation unit. In some embodiments, the energy storage unit is an electrochemical energy storage unit, for example a battery storage unit and/or a (redox) flow battery, a thermal storage unit (heat storage unit), a thermomechanical and/or mechanical storage unit, for example a flywheel, and/or some other storage unit that allows the storage and withdrawal of energy.

Use of the energy storage unit or of its partial capacities in the sense of the present disclosure means any use of the energy storage unit, for example for storing energy, for buffer-storing energy, for withdrawing energy and/or for some other use, for example as an emergency power reserve. In the context of this disclosure, a distinction is drawn only between the internal and external use of the energy stored by way of the energy storage unit, wherein the relative terms internal and external refer to the energy subsystem comprising the energy storage unit.

An optimization in the sense of the present disclosure is a mathematical optimization based on an objective function. The objective function is in this case minimized or maximized. In other words, the values of the variables of the objective function are determined such that the objective function is minimized or maximized. In this sense, optimum means that the objective function is minimized or maximized.

The objective function is typically optimized under a plurality of secondary conditions that variables and/or parameters of the objective function have to satisfy. The optimization, that is to say the finding of the optimum objective function and thus the optimum values of the variables of the objective function, is typically only possible with computer aid for extremely complex systems, for example such as energy systems in the present case. In this case, the operation of the energy system is optimized by way of the optimization, for example with regard to the highest possible energy efficiency of the energy system, the lowest possible carbon dioxide emission and/or the lowest possible costs/operating costs.

In other words, the most optimum possible future operation of the energy system is typically simulated. The energy system is able to be operated as optimally as possible in the future by way of this simulation. The simulation/optimization is particularly necessary because it is not possible to install or build innumerable energy systems in order to find an energy system that is as optimum as possible. The parameters provided for the optimization, which parameters for example parameterize or initialize the objective function, are typically physical variables that were acquired at a given point in time or from historical data by way of measurements on the present energy system. In other words, the parameterization and thus the objective function are based on physically acquired measurement data from the energy system. This ensures that the energy system is modeled in a physically realistic manner by the objective function. The computer-aided optimization thus provides an important technical tool for those skilled in the art in order to design and/or to operate energy systems as efficiently as possible.

An energy subsystem of the energy system is a subunit of the energy system that provides and/or consumes energy. By way of example, a single-family dwelling that has a photovoltaic system and a battery storage unit is one such energy subsystem.

In some embodiments, the total capacity of the energy storage unit of the energy subsystem is divided into the first partial capacity and the second partial capacity. This takes place in this case for or in the optimization. In other words, the energy storage unit is not divided physically, but rather a virtual division takes place in the optimization, this being performed by the control unit or being able to be performed thereby. In this case, the first partial capacity is intended for internal use with respect to the energy system subsystem. The second partial capacity is intended for external use with respect to the energy subsystem, for example for use by further energy subsystems of the energy system.

In this case, the total capacity of the energy storage unit is equal to the sum of the first and second partial capacity. In some embodiments, the optimization thus symbolically knows which or how much of the energy stored by way of the energy storage unit is intended for internal or external use. In other words, the division of the energy storage unit makes it possible to track which amount of energy is intended for internal use and which amount of energy is intended for external use. The control unit that enables this division and this identification of the energy in this case forms a central control unit with respect to the energy subsystems of the energy system.

In some embodiments, the virtual division of the energy storage unit by the control device does not take place on an a priori, ad-hoc or manual basis, but rather has been calculated or determined as optimally as possible based on the optimization. The energy storage unit may thereby be operated as optimally as possible with respect to its internal and/or external use. Since the energy storage unit is divided only virtually within the optimization, the partial capacities have the same physical charging conditions and discharging conditions. Costs and/or taxes may therefore be incurred and deducted for the use of the energy stored by way of the first partial capacity. Charging remuneration and/or discharging remuneration may be provided for the second partial capacity.

Some embodiments include an energy system that enables optimum operation of the energy storage unit with respect to its own consumption of the energy and external use by further energy subsystems. In other words, mixed operation (internal/external) of the energy storage unit is advantageously made possible. In this case, no structural modifications to the energy storage unit are required. In other words, pre-existing energy storage units according to the present invention may be integrated without any further structural outlay.

In some embodiments, the mixed operation of the energy storage unit also provides flexibility of the energy system with regard to the generation and consumption of energy. This leads overall to higher resource efficiency since, for example, the energy storage unit of an energy subsystem is able to be used by a further energy subsystem of the energy system. Overall, this promotes and increases the proportion of renewable energies in the energy system. This also takes place as efficiently as possible, that is to say that the energy storage unit is operated in an optimized manner for internal and external use.

In some embodiments, the burden of proof also lies with the operator of the energy storage unit in accordance with Section 61k EEG (Erneuerbare Energien Gesetz, German Renewable Energies Act).

In some embodiments, the local energy market comprises an energy system having a plurality of energy subsystems and a power network that electrically couples the energy subsystems in order to exchange electrical energy, wherein electrical energy is able to be exchanged between the energy subsystems by way of the power network in accordance with the optimization, and the optimization is able to take into consideration offers and/or bids, transmitted to the control unit, of the energy subsystems with regard to their consumption and/or provision of electrical energy.

In other words, the energy subsystems within the local energy market may submit offers to sell their generated electrical energy or offers to procure electrical energy. The offers are in this case taken into consideration by the control unit in the optimization. The division of the energy storage unit into the first and second partial capacity, that is to say into internal and external use with respect to one of the energy subsystems, is likewise taken into consideration. Further forms of energy, for example heat and/or cold, may additionally or alternatively be provided in the same way as electrical energy, for example by way of a heating network, district heating network and/or cooling network.

In some embodiments, a method for operating an energy system, wherein the energy system comprises at least one energy subsystem and a central control unit, and the energy subsystem has an energy storage unit having a total storage capacity, and the control unit controls the energy storage unit based on an optimization, is characterized in that the total storage capacity of the energy storage unit is divided into a first partial capacity and a second partial capacity by the control unit for the optimization, wherein the first partial capacity is used for internal use with respect to the energy subsystem and the second partial capacity is used for external use with respect to the energy subsystem.

In some embodiments, the first and second partial capacity are variables of the optimization. In other words, the first and second partial capacity are taken into consideration in the optimization in that they form variables of the objective function. As a secondary condition of the optimization, use may be made of the fact that the sum of the two partial capacities is always less than or equal to the total capacity, in particular equal to the total capacity of the energy storage unit. The (virtual) division of the total capacity of the energy storage unit is thereby advantageously optimized as far as possible.

In some embodiments, the control unit is designed to control charging and/or discharging of the energy storage unit based on a solution to the optimization. In other words, the control unit is designed to operate the energy storage unit in accordance with the solution to the optimization and, if necessary, taking into consideration trading results of the local energy market. The energy storage unit may be operated as optimally as possible by the control unit in accordance with the solution to the optimization. This may further improve the efficiency of the energy system. It is in particular ensured that the energy storage unit and the energy subsystems are operated in accordance with the solution to the optimization.

In some embodiments, the energy system comprises a data interface for transferring data containers between the energy subsystem and the control unit, wherein the data of the transferred data containers are able to be taken into consideration by the control unit at least partially in the optimization. In other words, information in the form of data or data containers may be exchanged bidirectionally or unidirectionally between the control unit and the energy subsystems by way of the data interface. The data may in this case be at least partially taken into consideration by the control unit in the optimization. By way of example, measured data that correspond to or are based on parameters of the energy system are transmitted to the control unit by the energy subsystems and taken into consideration in the optimization.

In some embodiments, the energy system comprises a database for storing and/or reading the data containers exchanged by way of the data interface. The transmitted data may thereby in particular be stored by the control unit, such that the control unit is aware of the real operating behavior of the respective energy subsystems. It is possible to determine from this whether the energy storage unit has been operated in accordance with the present invention. In some embodiments, the database may be formed with its blockchain.

In other words, a central database that is present for example within the control unit is not formed, but rather a decentralized database is formed by way of a blockchain. Nevertheless, the control unit may at least partially, in particular completely, comprise the blockchain. The blockchain may also be distributed in a decentralized manner among the individual energy subsystems of the energy system. In some embodiments, provision may be made for a central database, for example of a network operator.

In some embodiments, with regard to the local energy market, the offers and/or bids may be transmitted to the control unit peer-to-peer and/or by way of a blockchain. As an alternative or in addition, this may take place by querying a central database.

In some embodiments, the energy subsystem comprising the energy storage unit is a single-family dwelling or a multiple-family dwelling. Typical local energy producers and energy consumers, that is to say single-family dwellings and multiple-family dwellings, may thereby be incorporated by the local energy system. Each single-family dwelling or each multiple-family dwelling in this case forms a respective energy subsystem of the energy system. In particular, single-family dwellings provide electrical energy by way of a photovoltaic system. Some of the single-family dwellings and/or multiple-family dwellings may furthermore each have an energy storage unit that is able to be used in an effective and particularly efficient manner by further single-family dwellings and/or multiple-family dwellings of the energy system. In other words, the energy storage unit of one of the single-family dwellings or multiple-family dwellings may be used for the further single-family dwellings or multiple-family dwellings of the energy system by virtue of the present invention and/or one of its embodiments. In some embodiments, the energy subsystem comprising the energy storage unit may be a commercial facility, an industrial facility and/or some other technical system. In some embodiments, the energy system comprises a plurality of energy subsystems and a power network that electrically couples the energy subsystems in order to exchange electrical energy.

The figure shows a block diagram of an energy system 1 according to one embodiment of the teachings of the present disclosure or a local energy market 10. The figure is explained with reference to the example of the local energy system 1 and for electrical energy, wherein what has been stated may be transferred directly and unambiguously to the local energy market 10 and other forms of energy, for example heat and/or cold.

The energy system 1 comprises an energy subsystem 4, for example a single-family dwelling, having an energy storage unit 40, for example a battery storage unit. The energy system 1 furthermore comprises further energy subsystems 5, for example further single-family dwellings and/or multiple-family dwellings. The further energy subsystems 5 may likewise have an energy storage unit or a plurality of energy storage units, for example battery storage units. In some embodiments, the energy may include thermal energy instead or in addition to electrical energy.

The energy subsystem 4 and the further energy subsystems 5 are coupled via a power network 7 in order to exchange electrical energy, that is to say electric power or electricity. The energy system 1 furthermore comprises a central control unit 2 having a database 3. The control unit 2 is not assigned to any of the energy subsystems 4, 5, but rather is superordinate to the energy subsystems 4, 5 in this regard and is thus central with respect to the energy subsystems 4, 5. In this sense, the control unit 2 forms a central coordination platform that controls, regulates and/or coordinates the distribution of energy within the energy system.

The energy subsystem 4, which contains the energy storage unit 40, furthermore comprises a photovoltaic system 45 and an electrical load 46. The photovoltaic system generates electrical energy (power) that is able to be fed into the power network 7 and/or stored or buffer-stored by way of the energy storage unit 40. The infeed of power is identified by the arrow having the reference sign 424. The energy subsystem 4 may furthermore draw power from the power network 7. This reference is identified by the arrow having the reference sign 423. The infeed 424 and withdrawal 423 constitute physical flows. The energy storage unit 40, for example a battery storage unit, of the energy subsystem 4 may likewise be charged from the power network 7 via the reference 423. The energy storage unit 40 may likewise be physically discharged via the power network 7, this being identified by the reference sign 424.

The energy subsystem 4 furthermore comprises a local measuring unit 43 and a local control unit 44. The local control unit 44 is intended to locally control the energy storage unit 40. The local control unit 44 is in turn able to be controlled by way of the central control unit 2, such that the energy storage unit 40 is able to be controlled overall by way of the central control unit 2.

The local measuring unit 43 may acquire or measure values of physical variables of the energy storage unit and/or of the energy subsystem 4. The measuring unit 43 may furthermore transmit the acquired measured variables (measured values/measured data) to the central control unit 2 by way of a data interface 523, for example for storage within the database 3. The transmitted measured data may be taken into consideration when optimizing the operation of the energy system 1 as performed by the control unit 2. The further energy subsystems 5 have a corresponding data interface 523. The further energy subsystems 5 furthermore have a corresponding interface 423 for procuring electrical energy from the power network 7 and 424 for feeding electrical energy into the power network 7.

The control unit 2 is designed to divide the total capacity of the energy storage unit 40 into a first partial capacity 41 and a second partial capacity 42. This virtual division of the energy storage unit 40 is symbolized by the reference sign 24 in the figure. A corresponding virtual power procurement is symbolized or identified by the arrow 421, and a corresponding virtual power output is symbolized or identified by the arrow 422. The division 24 of the energy storage unit 40 is taken into consideration by the control unit 2 when optimizing the operation of the energy system 1, in particular when optimizing the operation of the energy subsystem 4. In other words, the first partial capacity 41 and the second partial capacity 42 are variables of an objective function that is optimized, that is to say is minimized or maximized.

The first partial capacity 41 is furthermore intended for internal use and the second partial capacity 42 is intended for external use with respect to the energy subsystem 4. In other words, the power of the energy storage unit 40 identified by way of the second partial capacity 42 is intended for the further energy subsystems 5. The electric power identified by way of the first partial capacity 41 is intended for internal use, that is to say for use within the energy subsystem 4 (its own consumption). Separation or identification, with respect to internal and external use, of the power stored by way of the energy storage unit 40 may thereby advantageously take place. In some embodiments, the division 24 in this case does not take place on an a priori, ad-hoc, manual and/or fixed basis, but rather is determined or calculated as optimally as possible by the control unit 2. This is the case because the first partial capacity 41 and the second partial capacity 42 are taken into consideration as variables in the optimization. As a secondary condition, provision is made here for the sum of the partial capacities 41, 42 to give the total capacity, that is to say the total physical capacity of the energy storage unit 40. The present invention thereby enables mixed operation of the energy storage unit 40 with respect to internal and external use that is as optimum as possible. It is thus possible to optimize the energy storage unit's own consumption and to perform market-side optimization of the energy storage unit 40 for the local energy market 10. This in particular results in greater flexibility for the local energy market 10.

The central database 3 may furthermore be used to check the actual operation of the energy subsystems 4, 5, for example on the basis of measured data that have been acquired by way of the measuring unit 43 and transmitted to the central control unit 2 or the database 3 by way of the data interface 400 or 523. It is thus likewise possible to monitor the optimum operation of the energy subsystems 4, 5 as calculated and determined in accordance with the central control unit 2.

The optimum calculation of the partial capacities 41, 42 by way of the control unit 2 is typically time-dependent. In other words, the division 24 of the energy storage unit 40 into the first and second partial capacity 41, 42 is typically dynamic over time. The distribution is thus flexibly optimized to the energy flows within the energy system. By way of example, a time increment of the optimization is one hour, a quarter of an hour or a shorter time range. The time increments that are used may be dependent on the optimization horizon, that is to say on the period that is considered as a whole in the optimization, for example one year or one day (day ahead).

The teachings herein thus allow mixed operation of the energy storage unit 40 with respect to the internal and external use of the stored energy, such that both the internal operation and the external and overall operation of the local energy market are improved. Although the teachings have been described and illustrated in more detail by way of exemplary embodiments, the scope of the disclosure is not restricted by the disclosed examples or other variations may be derived therefrom by a person skilled in the art without departing from the scope of protections of the invention.

### LIST OF REFERENCE SIGNS

1 energy system

2 central control unit

3 database

4 energy subsystem

5 further energy subsystems

10 local energy market

24 division of the total storage capacity

40 energy storage unit

41 first partial capacity

42 second partial capacity

43 local measuring unit

44 local control unit

45 photovoltaic system

46 electrical load

421 virtual power procurement

422 virtual power output

423 physical power procurement

424 physical power output

523 data interface

What is claimed is:

1. An energy system, comprising:
a central control unit; and
an energy subsystem including an energy storage unit having a total storage capacity;
wherein the central control unit is programmed to control the energy storage unit based on an optimization;
wherein the total storage capacity of the energy storage unit is divided into a first partial storage capacity and a second partial storage capacity by the control unit for the optimization;
wherein the first partial storage capacity is designated for interanal use with respect to the energy subsystem; and
the second partial storage capacity is designated for external use with respect to the energy subsystem.

2. The energy system as claimed in claim 1, wherein the first and second partial storage capacity are used as variables in the optimization.

3. The energy system as claimed in claim 1, wherein the control unit is programmed to control charging and/or discharging of the energy storage unit based on a solution to the optimization.

4. The energy system as claimed in claim 1, further comprising a data interface for transferring data containers between the energy subsystem and the control unit;
wherein the data of the transferred data containers are considered by the control unit in the optimization.

5. The energy system as claimed in claim 4, further comprising a database for storing and/or reading the data containers exchanged by way of the data interface.

6. The energy system as claimed in claim 5, wherein the database is formed by a blockchain.

7. The energy system as claimed in claim 4, wherein:
the energy subsystem comprises a measuring unit for acquiring physical measured variables of the energy storage unit;
the acquired measured variables are transferred by the measuring unit to the control unit via the data interface using data containers.

8. The energy system as claimed in claim 1, wherein the energy subsystem comprises a single-family dwelling or multiple-family dwelling.

9. The energy system as claimed in claim 1, further comprising a plurality of energy subsystems and a power network that electrically couples the energy subsystems to exchange electrical energy.

10. A local energy market comprising:
a plurality of energy subsystem; and
a power network that electrically couples the energy subsystem to exchange electrical energy; and
wherein electrical energy is exchanged between the individual energy subsystems by the power network based on an optimization, and
the optimization considers offers and/or bids transmitted to the control unit by the energy subsystems with regard to their consumption and/or provision of electrical energy.

11. A local energy market as recited in claim 10, wherein the offers and/or bids are able to be transmitted to the control unit peer-to-peer and/or by way of a blockchain.

12. A local energy market as recited in claim 10, wherein at least one energy subsystem is programmed to transmit an offer for the storage of electrical energy by way of the energy storage unit to the control unit.

13. A method for operating an energy system including an energy subsystem and a central control unit, wherein the energy subsystem has an energy storage unit having a total storage capacity and the control unit controls the energy storage unit based on an optimization, the method comprising:
dividing the total storage capacity of the energy storage unit into a first partial storage capacity and a second partial storage capacity by the control unit;
wherein the first partial storage capacity is used for internal use with respect to the energy subsystem; and
the second partial storage capacity is used for external use with respect to the energy subsystem.

14. The method as claimed in claim 13, further comprising controlling charging and/or discharging of the energy storage unit based on a solution to the optimization.

15. The method as claimed in claim 13, wherein:
the energy system includes a plurality of energy subsystems; and
the control unit controls the exchange of electrical energy between the energy subsystems based on the optimization, taking into consideration the division of the energy storage unit into the first and second partial capacity.
